(19) United States
(12) Patent Application Publication
(10) Pub. No.: US 2024/0253995 A1
(43) Pub. Date: Aug. 1, 2024

(54) SILICON/GRAPHENE COMPOSITE ANODE MATERIAL AND METHOD OF PREPARING SAME

(71) Applicants: CBBS, Co., Ltd., Daegu (KR); University of Ulsan Foundation For Industry Cooperation, Ulsan (KR)

(72) Inventors: Chan Byon, Daejeon (KR); Jiwon JUNG, Sejong-si (KR)

(73) Assignees: CBBS, Co., Ltd., Daegu (KR); University of Ulsan Foundation For Industry Cooperation, Ulsan (KR)

(21) Appl. No.: 18/596,652

(22) Filed: Mar. 6, 2024

Related U.S. Application Data
(63) Continuation of application No. PCT/KR2023/016318, filed on Oct. 20, 2023.

(30) Foreign Application Priority Data
Nov. 2, 2022 (KR) 10-2022-0144526

(51) Int. Cl. C01B 33/02; C01B 32/184; C01B 32/194; C01B 32/23; H01M 4/02; H01M 4/36; H01M 4/38; H01M 4/587

(52) U.S. Cl. CPC C01B 33/02; C01B 32/184; C01B 32/194; C01B 32/23; H01M 4/366; H01M 4/386; H01M 4/587; C01B 2204/04; C01B 2204/22; C01B 2204/32; C01P 2004/61; C01P 2004/62; C01P 2004/64; C01P 2004/80; C01P 2006/40; H01M 2004/027

(57) ABSTRACT

A method of preparing a silicon/graphene composite anode material, includes spray drying and then heat treating an aqueous graphene oxide solution, reduced graphene oxide powder, commercial carbon sources, polymers including salts and silicates, water-soluble polymers, and silicon metal particles, the aqueous graphene oxide solution being prepared by a modified Hummer's method and reduced graphene oxide powder being prepared by drying and reducing the aqueous solution. The anode material is advantageous in suppressing the high volume expansion during charging and discharging of the anode material and the resultant micronization of silicon and excessive formation of a solid electrolyte interphase (SEI) on the surface of the anode material. Not only that, the anode material enables the stable operation of secondary batteries based on silicon anode materials and at the same time can exhibit the high capacitance inherent to silicon.

### CROSS-REFERENCE TO RELATED APPLICATION

This application is a continuation of PCT International Patent Application No. PCT/KR2023/016318 filed on Oct. 20, 2023, which claims priority to Korean Patent Application No. 10-2022-0144526 filed on Nov. 2, 2022, which are all hereby incorporated by reference in their entirety.

### BACKGROUND OF THE INVENTION

The present disclosure relates to a silicon/graphene composite anode material and a method of preparing the same. More specifically, the present disclosure relates to a silicon/graphene composite anode material and a method of preparing the same, the method including spray-drying and then heat-treating an aqueous graphene oxide solution, reduced graphene oxide powder, commercial carbon sources, polymers including salts and silicates, water-soluble polymers, and silicon metal particles, the aqueous graphene oxide solution being prepared by a modified Hummer's method and the reduced graphene oxide powder being prepared by drying and reducing the aqueous solution. The silicon/graphene composite anode material is advantageous in suppressing the high volume expansion during charging and discharging of the anode material and the resultant micronization of silicon and excessive formation of a solid electrolyte interphase (SEI) on the surface of the anode material. In addition, the silicon/graphene composite anode material enables the stable operation of secondary batteries based on a silicon anode material and at the same time can exhibit the high capacitance inherent to silicon.

Graphene has a two-dimensional nanostructure made of one layer of carbon and is a single-layer hexagonal lattice material made up of sp2 hybridized carbon atoms. The graphene has a form where the hexagonal crystal lattice is piled up in a layered structure, resulting in complete layer separation in graphite being in a layered structure. Graphene was first manufactured using the “Scotch Tape method” at the University of Manchester in the UK in 2004. Later, in 2008, the outstanding strength of graphene was confirmed at Columbia University in the United States. In the same year, Columbia University in the United States showed that graphene had a thermal conductivity of 5,300 W/mK, which was twice that of carbon nanotubes. When carbon nanotubes are cut lengthwise, a graphene structure is created. When the diameter of the carbon nanotubes wall becomes infinitely large, the structure of the carbon nanotubes becomes similar to the graphene structure. Therefore, graphene's electrical, thermal, and mechanical properties are comparable to carbon nanotubes. Meanwhile, compared to carbon nanographene, graphene has a plate-like structure unlike carbon nanotubes with a needle-like structure, so graphene can have many edges to be easily functionalized for a given purpose, have a larger active surface area, and be used for purposes such as shielding. In addition, graphene is the thinnest material in existence, so graphene has a higher current density than copper and also has the property of showing the quantum Hall effect even at room temperature, the quantum Hall effect generally being only observed at extremely low temperatures. Additionally, graphene is the most outstanding material among existing materials in terms of strength, thermal conductivity, and electron mobility. Therefore, graphene is recognized as a strategic core material that will drive the growth of related industries by being applied to various fields such as displays, secondary batteries, solar cells, polymer composites, compounding, paints, and heat dissipation.

Meanwhile, in relation to secondary batteries, the demand for ultra-large power storage systems has recently increased rapidly with various electronic devices becoming smaller and lighter. Accordingly, worldwide interest in new energy sources is increasing. Among the energy sources, research and development are focused on the field of secondary batteries that are eco-friendly, have high energy density, and are capable of rapid charging and discharging. In particular, carbon-based, metal-based, and oxide-based materials used for negative electrode active materials of lithium secondary batteries have various types thereof as well as play a key role in improving high-output, high-density energy power. A lot of research and commercialization is being done on those materials. Among the carbon-based materials referred to as negative electrode active materials, graphite is an excellent material that is very stable and does not involve volume expansion. However, graphite is inadequate as a negative electrode active material for mobile devices due to limitations in theoretical capacity since mobile devices require high capacity. Therefore, new high-capacity materials to be used as negative electrode active materials are required, and among the new high-capacity materials, silicon (Si) has a high theoretical capacity. Silicon is a metal element that can charge and discharge lithium ions through alloying and dealloying with lithium (Li). Silicon is superior to graphite, which is a conventional negative electrode active material, in terms of capacity per weight and volume. Thus, silicon is being actively researched as a next-generation high-capacity lithium secondary battery material.

Korean Patent Registration No. 10-1399042 relates to a negative electrode active material to improve the energy density and lifespan of lithium secondary batteries that require high output and high voltage. The registered patent discloses a high-capacity anode material and preparation technology thereof to improve the energy storage characteristics and lifespan of medium to large-sized lithium secondary batteries. In addition, Korean Patent Registration No. 10-2405622 discloses a secondary battery anode material of silicon-graphene-carbon nanotube core-shell composite and a method of preparing the same. In the registered patent, the anode material of silicon-graphene-carbon nanotube core-shell composite in the secondary battery includes lithium titanate and silicon-graphene-carbon nanotube core-shell powder. Here, the silicon contained in the silicon-graphene-carbon nanotube core-shell powder has its surface already surface-modified with an alkoxy silane-based surface modifier to be coated with graphene and carbon nanotubes. In addition, Korean Patent Registration No. 10-2241526 discloses electrodes for secondary batteries containing a high-density anode material and a method of preparing the same to maximize the characteristics of the composite used for the anode material, which includes low-defect/high-purity reduced graphene oxide and silicon metal particles. The high-density anode material includes a reduced graphene oxide-silicon metal particle composite that can improve the high capacity and stable cycle performance of secondary battery electrodes. Here, the secondary battery electrodes contain an anode material prepared by a method of maximizing packing density thereof by applying an anode material slurry, and the anode material slurry is prepared by mixing natural graphite and artificial graphite of different sizes and shapes to a current collector.

As mentioned above, there are various anode material preparation technologies using silicon-graphene. However, commercialization is not easy despite silicon's high theoretical capacity characteristics. The reason is that when absorbing and storing lithium ions, a large volume expansion of more than 300% occurs due to changes in the crystal structure. Additionally, continued volume changes cause the structure of silicon to break down, which reduces initial efficiency and cycle characteristics. This means that technology to improve the reversibility of lithium secondary batteries and maintain high capacity is essentially needed. Thus, there is a need to develop a graphene/silicon anode material that can solve the problems.

### SUMMARY OF THE INVENTION

The present disclosure is created to solve the problems described above and provide a necessary technology.

The present disclosure is to provide a silicon/graphene composite anode material and a method of preparing the same, the method including spray-drying and then heat-treating an aqueous graphene oxide solution, reduced graphene oxide powder, commercial carbon sources, polymers including salts and silicates, water-soluble polymers, and silicon metal particles, the aqueous graphene oxide solution being prepared by a modified Hummer's method and reduced graphene oxide powder being prepared by drying and reducing the aqueous solution. The silicon/graphene composite anode material is advantageous in suppressing the high volume expansion during charging and discharging of the anode material and the resultant micronization of silicon and excessive formation of a solid electrolyte interphase (SEI) on the surface of the anode material. Not only that, the silicon/graphene composite anode material enables the stable operation of secondary batteries based on silicon anode materials and at the same time can exhibit the high capacitance inherent to silicon.

According to an embodiment of the present disclosure to solve the technical problems, a method of preparing a silicon/graphene composite anode material is provided, the method including:
a graphene oxide preparation step of preparing an aqueous graphene oxide solution through a modified Hummer's method;
a reduced graphene oxide preparation step of preparing reduced graphene oxide powder by freeze-drying and then thermally reducing the aqueous graphene oxide solution obtained in the graphene oxide preparation step;
a composite dispersion solution preparation step of preparing composite dispersion solution by adding silicon metal particles, a cross-linking agent, and water-soluble polymers to the aqueous graphene oxide solution obtained in the graphene oxide preparation step and the reduced graphene oxide powder obtained in the reduced graphene oxide preparation step, and then stirring and dispersing the mixture; and
a composite powder preparation step of preparing silicon/graphene composite powder with a core-shell structure by spray-drying the composite dispersion solution obtained in the composite dispersion solution preparation step.

In the graphene oxide preparation step of the present disclosure, the aqueous graphene oxide solution is prepared through the modified Hummer's method, the method including:
an oxidation step of preparing a graphite oxide slurry by mixing expanded graphite, potassium permanganate, water, and sulfuric acid, stirring the mixture, and reacting the mixture at a predetermined consistent temperature for a predetermined time;
a filtration step of mixing 50 to 200 parts by weight of water, based on 100 parts by weight of the prepared graphite oxide slurry, with the slurry, and then centrifuging the mixture to remove the filtrate and obtain the graphite oxide slurry; and
   a graphene oxide preparation step of preparing the aqueous graphene oxide solution by mixing 5000 to 20000 parts by weight of water, based on 100 parts by weight of graphite oxide slurry separated in the filtration step, with the slurry, and then removing impurities in an ion exchange resin column and filtering out impurities.

In addition, the graphene oxide and reduced graphene oxide have a lateral size in a range of 1 to 100 μm based on a medium particle size (D50) and a thickness in a range of 0.6 to 10 nm.

In the composite dispersion solution preparation step, the aqueous graphene oxide solution/reduced graphene oxide powder mixture is added and dispersed in an amount of 1 to 3 parts by weight, based on 100 parts by weight of the silicon metal particles.

At this time, the aqueous graphene oxide solution/reduced graphene oxide powder mixture is obtained by mixing the reduced graphene oxide powder with the aqueous graphene oxide solution, the reduced graphene oxide powder being in an amount of within 200 parts by weight, based on 100 parts by weight of the aqueous graphene oxide solution.

In addition, the silicon metal particles have a size in a range of 0.05 to 5 μm.

In addition, the silicon metal particles have a size in a range of 0.5 to 1 μm.

In addition, in the composite dispersion solution preparation step, the commercial carbon sources made of at least one selected from the group consisting of natural graphite, artificial graphite, carbon black, acetylene black, graphite intercalated compounds (GICs), expanded graphite, activated carbon, graphene nanoplatelets (GNPs), and carbon nanotubes (CNTs) are further added, dispersed, and mixed.

Additionally, the cross-linking agent is made of monomers containing silicates.

At this time, the monomers containing the silicates are any one selected from the group consisting of tetraethoxysilane, n-octyltriethoxysilane, siloxane, and vinyltrimethoxysilane.

Additionally, in the composite dispersion solution preparation step, a silicate salt is further included.

Additionally, the water-soluble polymers are at least one selected from the group consisting of polyvinyl alcohol, polyethylene glycol, polyethyleneimine, polyamideamine, polyvinyl formamide, polyvinyl acetate, polyacrylamide, polyvinylpyrrolidone, polydiallyldimethylammonium chloride, polyethyleneoxide, polyacrylic acid, polystyrenesulfonic acid, polysilicic acid, polyphosphoric acid, polyethylenesulfonic acid, poly-3-vinyloxypropane-1-sulfonic acid, poly-4 vinylphenol 4-vinylphenol, poly-4-vinylphenyl sulfuric acid, polyethyleneohosphoric acid, polymaleic acid, poly-4-vinylbenzoic acid, methyl cellulose, hydroxy ethyl cellulose, carboxy methyl cellulose, sodium carboxy methyl cellulose, hydroxy propylcellulose, sodium carboxymethylcellulose, polysaccharide, and starch, and mixtures thereof.

Additionally, in the composite powder preparation step, the composite dispersion solution obtained in the composite dispersion solution preparation step is spray-dried at a temperature in a range of 100° C. to 250° C.

In addition, the composite powder obtained in the composite powder preparation step has a size in a range of 1 to 100 μm.

In addition, after the composite powder preparation step, the method further includes heat-treating of the composite powder obtained in the composite powder preparation step at a temperature in a range of 100° C. to 500° C. for 30 minutes to 4 hours under any gas atmosphere of air, nitrogen, or argon.

The present disclosure provides a silicon/graphene composite anode material having a core-shell structure in which the core is made of silicon metal particles and the shell is made of graphene.

Another embodiment of the present disclosure provides the silicon/graphene composite anode material prepared by the method described above and with a core-shell structure.

The silicon/graphene composite anode material prepared according to one embodiment of the present disclosure is prepared by a method of spray-drying and then heat-treating an aqueous graphene oxide solution, reduced graphene oxide powder, commercial carbon sources, polymers including salts and silicates, water-soluble polymers, and silicon metal particles, the aqueous graphene oxide solution being prepared by a modified Hummer's method and reduced graphene oxide powder being prepared by drying and reducing the aqueous solution. The silicon/graphene composite anode material is advantageous in suppressing the high volume expansion during charging and discharging of the anode material and the resultant micronization of silicon and excessive formation of a solid electrolyte interphase (SEI) on the surface of the anode material. Not only that, the silicon/graphene composite anode material enables the stable operation of secondary batteries based on silicon anode materials and at the same time can exhibit the high capacitance inherent to silicon.

### BRIEF DESCRIPTION OF DRAWINGS

FIG. 1 is a flowchart showing a method of preparing a silicon/graphene composite anode material by process step;

FIG. 2 is a photograph showing the state of the silicon/graphene composite;

FIG. 3 is a graph showing the results of the charge/discharge test of a silicon/graphene composite anode material; and

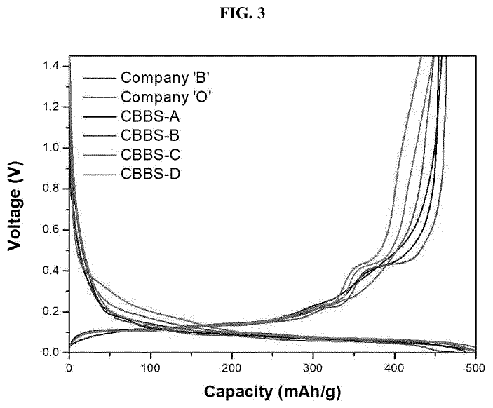

FIG. 4 is a graph showing discharge capacity of the silicon/graphene composite anode material with respect to cycle number.

### DETAILED DESCRIPTION OF THE INVENTION

In an embodiment for a silicon/graphene composite anode material and method of preparing the same, the method of preparing the silicon/graphene composite anode material is provided, the method including:
a graphene oxide preparation step of preparing an aqueous graphene oxide solution through a modified Hummer's method;
a reduced graphene oxide preparation step of preparing reduced graphene oxide powder by freeze-drying and then thermally reducing the aqueous graphene oxide solution obtained in the graphene oxide preparation step;
a composite dispersion solution preparation step of preparing composite dispersion solution by adding silicon metal particles, a cross-linking agent, and water-soluble polymers to the aqueous graphene oxide solution obtained in the graphene oxide preparation step and the reduced graphene oxide powder obtained in the reduced graphene oxide preparation step, and then stirring and dispersing the mixture; and
   a composite powder preparation step of preparing silicon/graphene composite powder with a core-shell structure by spray-drying the composite dispersion solution obtained in the composite dispersion solution preparation step

### MODE FOR DISCLOSURE

Hereinafter, embodiments of the present disclosure will be described in detail so that those skilled in the art can easily implement the disclosure. The embodiments of the present disclosure are provided to more completely explain the present disclosure to those skilled in the art. Accordingly, the embodiments of the present disclosure may be modified into various other forms, and the scope of the present disclosure is not limited to the embodiments described below.

Throughout the specification of the present disclosure, when a part is said to “include” a certain element, this means that the part may further include other elements rather than excluding other elements unless specifically stated to the contrary.

The terms “about”, “substantially”, and the like used throughout the specification of the present disclosure are used to mean at or close to that value when manufacturing and material tolerances are presented corresponding to that inherent value. This is used to prevent unscrupulous infringers from unfairly exploiting the disclosure, which mentions precise or absolute figures to aid understanding of the disclosure. The term “step” or “step of” used throughout the specification does not mean “step for”.

The present disclosure relates to a method of preparing a silicon/graphene composite anode material, the method including a graphene oxide preparation step S100, a reduced graphene oxide preparation step S200, a composite dispersion solution preparation step S300, and a composite powder preparation step S400.

Hereinafter, the method of preparing the silicon/graphene composite anode material according to the embodiments of the present disclosure will be described in detail. The silicon/graphene composite anode material (hereinafter referred to as “anode material” or “composite anode material”) according to the embodiments of the present disclosure can be more clearly understood by the preparation method described later.

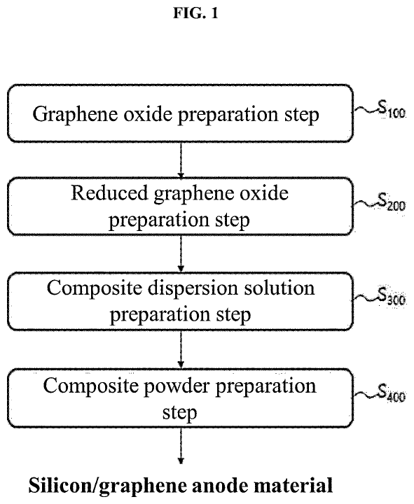

FIG. 1 is a flowchart showing a method of preparing a silicon/graphene composite anode material by process step.

First, a graphene oxide preparation step S100 is performed.

According to one embodiment of the present disclosure, in the oxidation of the graphene oxide preparation step S100, an aqueous graphene oxide solution is prepared through a modified Hummer's method.

According to another embodiment of the present disclosure, an aqueous graphene oxide solution is prepared through the modified Hummer's method, the method including:
an oxidation step of preparing a graphite oxide slurry by mixing expanded graphite, potassium permanganate, water, and sulfuric acid, stirring the mixture, and reacting the mixture at a predetermined consistent temperature for a predetermined time;
a filtration step of mixing 50 to 200 parts by weight of water, based on 100 parts by weight of the prepared graphite oxide slurry, with the slurry, and then centrifuging the mixture to remove the filtrate and obtain the graphite oxide slurry; and
   a graphene oxide preparation step of preparing the aqueous graphene oxide solution by mixing 5000 to 20000 parts by weight of water, based on 100 parts by weight of graphite oxide slurry separated in the filtration step, with the slurry, and then removing impurities in an ion exchange resin column and filtering out impurities.

Graphite oxide is easily dispersed in water and exists as a negatively charged thin film plate in polar solvents. Accordingly, to form graphene oxide, an exfoliation process is required. The oxidation step involves the use of a chemical exfoliation method called a modified Hummer's method. In general, when graphite itself is torn off layer by layer, graphene made up only of sp2 carbons is electrically and thermodynamically unstable and agglomerates on its own. However, when expanded graphite, potassium permanganate, water, and sulfuric acid are mixed and stirred to exfoliate the graphite through the strong oxidation reaction according to the present disclosure, it is possible to easily prepare graphene oxide stably.

Therefore, it is most desirable to prepare the aqueous graphene oxide solution through the modified Hummer's method, the method including:
an oxidation step of preparing a graphite oxide slurry by mixing expanded graphite, potassium permanganate, water, and sulfuric acid, stirring the mixture, and reacting the mixture at a predetermined consistent temperature for a predetermined time;
a filtration step of mixing 50 to 200 parts by weight of water, based on 100 parts by weight of the prepared graphite oxide slurry, with the slurry, and then centrifuging the mixture to remove the filtrate and obtain the graphite oxide slurry; and
   a graphene oxide preparation step of preparing the aqueous graphene oxide solution by mixing 5000 to 20000 parts by weight of water, based on 100 parts by weight of graphite oxide slurry separated in the filtration step, with the slurry, and then removing impurities in an ion exchange resin column and filtering out impurities.

Next, a reduced graphene oxide preparation step S200 may be performed.

A reduced graphene oxide preparation step of preparing reduced graphene oxide powder by freeze-drying and then thermally reducing the aqueous graphene oxide solution obtained in the graphene oxide preparation step may be performed.

In general, when organic solvents are used for graphene dispersion, freeze-drying is not suitable. However, in the present disclosure, by purifying and filtering using water, graphene oxide is stably dispersed, thereby facilitating freeze-drying.

Therefore, in the reduced graphene oxide preparation step, it is most desirable to prepare reduced graphene oxide powder by freeze-drying and then thermally reducing the aqueous graphene oxide solution obtained in the graphene oxide preparation step.

Next, a composite dispersion solution preparation step S300 may be performed. In the composite dispersion solution preparation step, composite dispersion solution is prepared by adding silicon metal particles, a cross-linking agent, and water-soluble polymers to the aqueous graphene oxide solution obtained in the graphene oxide preparation step and the reduced graphene oxide powder obtained in the reduced graphene oxide preparation step, and then stirring and dispersing the mixture.

According to yet another embodiment of the present disclosure, graphene oxide and reduced graphene oxide have a lateral size in a range of 1 to 100 μm based on a medium particle size (D50) and a thickness in a range of 0.6 to 10 nm.

The reason for limiting the lateral size is that it is easy to form graphene/silicon composite powder by surrounding clusters of silicon metal particles in a size of about several hundred nm. When the lateral size is below the limited range, the silicone cannot be sufficiently surrounded. When the lateral size is too large to surround the silicon, it is difficult to form a neat core-shell structure. Thus, graphene may be randomly folded. In addition, when the thickness exceeds 10 nm, the number of graphene layers is too large and the graphene becomes close to graphite, making it difficult to obtain expected rigidity. Not only that, during charging, it becomes difficult for lithium ions to penetrate inside.

In addition, the aqueous graphene oxide solution/reduced graphene oxide powder mixture is added and dispersed in an amount of 1 to 3 parts by weight, based on 100 parts by weight of the silicon metal particles.

This is because when the weight of graphene is too small, it cannot sufficiently surround the silicon, and when the weight is too large, it surrounds excessively, resulting in poor ionic conductivity.

At this time, the aqueous graphene oxide solution/reduced graphene oxide powder mixture is obtained by mixing the reduced graphene oxide powder with the aqueous graphene oxide solution, the reduced graphene oxide powder being in an amount of within 200 parts by weight, based on 100 parts by weight of the aqueous graphene oxide solution.

This is because when the mixture of reduced graphene oxide powder is added below the limited range, the amount of graphene is not sufficient to surround the silicon, and the conductivity is poor. In addition, when the mixture of reduced graphene oxide powder is added beyond the limited range, too much graphene will be contained, making it difficult to disperse, and the amount of silicon will decrease compared to the total volume of the anode material, reducing capacity, and hindering the smooth movement of lithium ions.

Graphene oxide is used since graphene oxide stays in a perfect one-layer sheet form in an aqueous solution, making it easy to surround silicon particles or clusters. In addition, graphene oxide increases the dispersibility and usability of reduced graphene oxide in a crumpled amorphous form rather than the one-layer sheet and with low water dispersibility. Thus, graphene oxide can be used to make a silicon/graphene composite with uniform and stable quality. In addition, the dispersibility of graphene oxide can provide graphene oxide the role of a dispersing agent so that reduced graphene oxide can also be stably dispersed in water. The reason why reduced graphene oxide is used together with graphene oxide is that the form of graphene, when used together, is closer to the theoretical form of graphene than when graphene oxide is used alone, and reduced graphene oxide has better electronic conductivity than graphene oxide.

In addition, the silicon metal particles have a size in a range of 0.05 to 5 μm. The silicon metal particles have a size in a range of 0.5 to 1 μm, but the size thereof is not limited thereto.

When the silicon metal particles are too small (less than 0.05 μm), the surface area will be large during battery manufacturing, resulting in the excessive formation of a solid film (SEI layer) on the surface of the anode material, which will reduce initial efficiency and overall applicability. Not only that, there is no need to consider the volume expansion and micronization of silicon particles as small as tens of nanometers during charging and discharging. When the silicon metal particles are too large (exceeding 1 μm), the cracking phenomenon due to volume expansion is so severe that surrounding the silicon metal particles with graphene becomes useless. In addition, when the effective interface becomes too small, decreases in charging speed and capacity may occur.

According to yet another embodiment of the present disclosure, commercial carbon sources made of at least one selected from the group consisting of natural graphite, artificial graphite, carbon black, acetylene black, graphite intercalated compounds (GICs), expanded graphite, activated carbon, graphene nanoplatelets (GNPs), and carbon nanotubes (CNTs) are further added, dispersed, and mixed.

The reason for the use of the commercial carbon sources is that the commercial carbon sources strengthen the bonding force of the silicon/graphene mixture and improve the charge conductivity inside the composite powder. Most preferably, it is desirable to use carbon black with the smallest particle size of 50 nm.

Additionally, the cross-linking agent is made of monomers containing silicates.

At this time, the monomers containing the silicates are any one selected from the group consisting of tetraethoxysilane, n-octyltriethoxysilane, siloxane, and vinyltrimethoxysilane.

The monomers containing the silicates serve as a cross-linking agent working between silicon and graphene, strengthening the bond between silicon and graphene while the monomers realize a hollow structure inside by removing the remaining parts except for the part where the cross-linking agent acts during the spray-drying or heat-treatment process. This is to ensure clearance to facilitate volume expansion of the silicon during charging and discharging.

Additionally, a silicate salt is further included.

The silicate salt is not limited thereto but may include salts such as lithium silicate. The purpose of the use of the silicate salt is to create a hollow structure inside the silicon-graphene anode material by removing salts through a solution preparation and filtering process after spray-drying. Additionally, the water-soluble polymers are selected from the group consisting of polyvinyl alcohol, polyethylene glycol, polyethyleneimine, polyamideamine, polyvinyl formamide, polyvinyl acetate, polyacrylamide, polyvinylpyrrolidone, polydiallyldimethylammonium chloride, polyethyleneoxide, polyacrylic acid, polystyrenesulfonic acid, polysilicic acid, polyphosphoric acid, polyethylenesulfonic acid, poly-3-vinyloxypropane-1-sulfonic acid, poly-4-vinylphenol 4-vinylphenol, poly-4-vinylphenyl sulfuric acid, polyethyleneohosphoric acid, polymaleic acid, poly-4-vinylbenzoic acid, methyl cellulose, hydroxy ethyl cellulose, carboxy methyl cellulose, sodium carboxy methyl cellulose, hydroxy propylcellulose, sodium carboxymethylcellulose, polysaccharide, and starch, and mixtures thereof.

Although not limited thereto, it is the most preferable to use polyvinyl alcohol.

Next, a composite powder preparation step S400 may be performed.

The composite powder preparation step may be performed in which silicon/graphene composite powder with a core-shell structure is prepared by spray-drying the composite dispersion solution obtained in the composite dispersion solution preparation step.

According to yet another embodiment of the present disclosure, the composite dispersion solution prepared in the composite dispersion solution preparation step is spray-dried at a temperature in a range of 100° C. to 250° C.

When the spray-drying temperature is too low, being below 100° C., the liquid of the composite dispersion solution will not fully-vaporized during spraying, and deposit in the container with residual-liquid. When the spray-drying temperature becomes too high, exceeding 250° C., the pressure inside the spray-dryer becomes excessively high. In addition, boiling may occur in the oxidized or dried powder, which can cause problems such as damaging the structure of the composite and increasing energy consumption.

At this time, the composite powder obtained in the composite powder preparation step has a size in a range of 1 to 100 μm.

When the size of the composite powder is less than 1 μm, the amount of silicon used is reduced, which reduces the capacity of the anode material. When the size of the composite powder exceeds 100 μm, poor uniformity may occur when applied to the cathode substrate.

Although the size is not limited thereto, it is the most preferable that composite powder obtained in the composite powder preparation step has a size of 10 μm.

After the composite powder preparation step, the method may further include heat-treating the composite powder obtained in the composite powder preparation step at a temperature in a range of 100° C. to 500° C. for 30 minutes to 4 hours under any gas atmosphere of air, nitrogen, or argon.

The purpose of the heat-treatment is to allow graphene to be more firmly bonded to silicon and to facilitate the formation of a hollow structure by removing the water-soluble polymers. When the heat-treatment temperature is too high, graphene oxide and reduced graphene oxide may be denatured or disappear through thermal decomposition. When the heat-treatment temperature is too low, sufficient firing will not occur.

In addition, the silicon/graphene composite anode material has a core-shell structure in which the core is made of silicon metal particles, and the shell is made of graphene.

Hereinafter, graphene according to an embodiment of the present disclosure can be more clearly understood through examples described later. These examples are only intended to aid understanding of the present disclosure, and the scope of the present disclosure is not limited to these examples in any way.

### Example 1

Preparation of silicon/graphene composite anode material

1. Graphene oxide preparation step:

1) Oxidation step: 300 parts by weight of potassium permanganate, 15,000 parts by weight of water, and 10,000 parts by weight of sulfuric acid, based on 100 parts by weight of expanded graphite, were mixed, and stirred. The mixture remained at a temperature of 60° C. and reacted for 3 hours to prepare a graphite oxide slurry.

2) Filtration step: 100 parts by weight of water, based on 100 parts by weight of the prepared graphite oxide slurry, was mixed with the slurry, and the mixture was centrifuged. The filtrate resulting from the centrifugation was removed, and the graphite oxide slurry was obtained.

3) Graphene oxide preparation step: 10,000 parts by weight of water, based on 100 parts by weight of graphite oxide slurry, was mixed with the slurry, and then impurities were purified in an ion resin exchange column and then filtered to prepare an aqueous graphene oxide solution.

2. Reduced graphene oxide preparation step: reduced graphene oxide powder was prepared by freeze-drying and then thermally reducing the aqueous graphene oxide solution.

3. Composite dispersion solution preparation step: a composite dispersion solution was prepared by adding silicon metal particles and a cross-linking agent to the aqueous graphene oxide solution and reduced graphene oxide powder, and then stirring and dispersing the mixture. The aqueous graphene oxide solution/reduced graphene oxide powder mixture was added and dispersed in an amount of 1 to 3 parts by weight, based on 100 parts by weight of the silicon metal particles to prepare a composite dispersion solution. Herein the premise was that the aqueous graphene oxide solution/reduced graphene oxide powder mixture was obtained by mixing the reduced graphene oxide powder with the aqueous graphene oxide solution, the reduced graphene oxide powder being in an amount of within 200 parts by weight, based on 100 parts by weight of the aqueous graphene oxide solution.

At this time, the graphene oxide and reduced graphene oxide had a lateral size in a range of 1 to 100 μm based on a medium particle size (D50) and a thickness in a range of 0.6 to 10 nm. The silicon metal particles had a size in a range of 0.5 to 1 μm.

In addition, at this time, carbon black, which was a commercial carbon source, could be further added.

Additionally, the cross-linking agent includes the monomers containing the silicates, which were any one selected from the group consisting of tetraethoxysilane, n-octyltriethoxysilane, siloxane, and vinyltrimethoxysilane. At this time, a silicate salt might be further included.

In addition, the water-soluble polymers used were polyvinyl alcohol.

4. Composite powder preparation step: silicon/graphene composite powder with a core-shell structure was prepared by spray-drying the composite dispersion solution at a temperature of 220° C. The core was made of silicon metal particles and the shell was made of graphene. The prepared composite powder had a size of 10 μm.

5. Heat-treatment step: the composite powder was heat-treated at a temperature of 200° C. for 1 hour under any gas atmosphere of air, nitrogen, or argon.

Four samples, which were A, B, C, and D, were prepared in the above manner and used in Example 2 below.

### Example 2

Quality properties of prepared silicon/graphene composite anode material

1. Confirmation of initial capacity and stability of silicon/graphene composite anode material

Table 1 below shows the results of the charge/discharge test for the anode material sample A prepared according to the present disclosure and the anode materials of other companies. Compared to the anode materials of other companies, the silicon/graphene composite anode material prepared according to the present disclosure had a very high initial capacity. This was because the original properties of silicon were improved using graphene. Since the anode materials of other companies were obtained by mixing silicon with a large amount of carbon sources and silica, the performance thereof was only achieved corresponding to the amount of silicon. Thus, the anode materials of other companies were found to have lower performance compared to the anode material of the present disclosure. However, the capacity retention rate of the anode material of the present disclosure was relatively low compared to the anode materials of other companies, which was believed to be due to the breaking phenomenon of silicon.

### Example 1

| | Initial | Initial | Capacity | | |
|---|---|---|---|---|---|
| | capacity | efficiency | retention | Price | |
| | (mAh/g) | (%) | rate (%) | ($/kg) | Property |
| H Company | 1506 | 88.1 | 88.4 | 59.3 | Si—C |
| D Company | 1408 | 89.0 | 91.7 | 71.2 | Si—Ox |
| M Company | 1108 | 89.4 | 88.0 | N/A | Si—C |
| Chinese B | 511 | 91.5 | 96.8 | 46 | Si—C |
| Company | | | | | |
| Japanese O | 1856 | 79.8 | 97.5 | 75 | Si—Ox |
| Company | | | | | |
| CBBS | 3214 | 78.2 | 93.2 | 40 | Si- |
| (sample A) | | | | | graphene |

2. State of the silicon/graphene composite

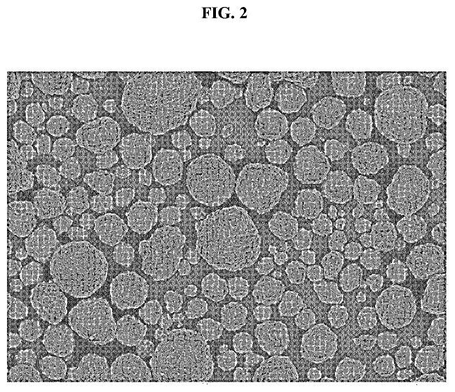

FIG. 2 below is a photograph showing the state of the silicon/graphene composite. The state of the silicon/graphene composite was confirmed for sample A. Looking at FIG. 2 below, graphene was found to effectively surround silicon clusters.

3. Composition comparison of silicon/graphene composite anode material

Table 2 shows composition of each sample, in terms of ratio of graphite and silicon set to meet target capacity, and solid content of slurry. The target capacity was set at 450 mAh/g, and 50 to 60% of solid content was appropriate. All the anode materials involved had a solid content of more than 50%.

### Example 2

| | | Slurry/Electrode | | | |
|---|---|---|---|---|---|
| | | Active | | Solid | |
| | Sample | materials | Target | content of | Re- |
| No. | name | Graphite:Si | capacity | Slurry (wt %) | mark |

| | | | | |
|---|---|---|---|---|
| 1 | Chinese B | 26:74 | 450 mAh/g | 54.8 |
| | Company | | | |
| 2 | Japanese O | 94:6 | | 54.8 |
| | Company | | | |
| 3 | sample A | 95.9:4.1 | | 55.1 |
| 4 | Sample B | 95.9:4.1 | | 55.1 |
| 5 | Sample C | 95.9:4.1 | | 55.1 |
| 6 | Sample D | 95.9:4.1 | | 55.1 |

4. Charge/discharge test of silicon/graphene composite anode material

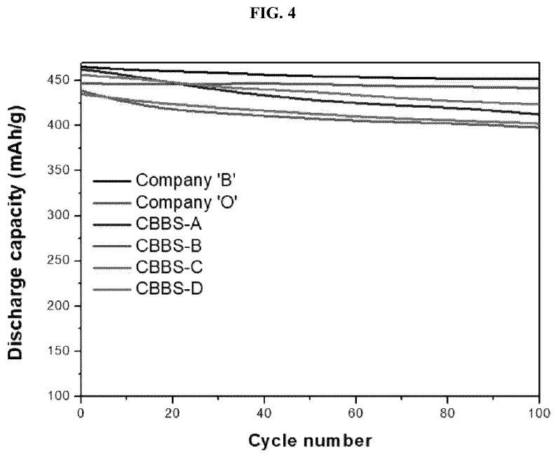

FIG. 4 is a graph showing discharge capacity of the silicon/graphene composite anode material with respect to cycle number. The X-axis represents the charge amount, the Y-axis represents the discharge amount, the L-shaped curve represents the charging curve, and the inverted L-shaped curve represents the discharge curve. As a result of the charge/discharge test of the anode material, it was confirmed that the discharge amount was less than the charge amount.

5. characteristics of silicon/graphene composite anode material depending on cycle number

FIG. 4 is s a graph of the cycle characteristics of the silicon/graphene composite anode material. A cycle number allows for judging the capacity maintenance rate. It was found that the discharge capacity was maintained at around 400 mAh/g without a significant decrease in discharge capacity up to 100 cycles.

Herein above, the present disclosure has been described in detail through examples. The present disclosure is not limited to the examples and may be modified into various forms. It is clear that many variations are possible within the technical spirit of the present disclosure by those skilled in the art. In addition, various forms of substitution, modification, and change may be made by those skilled in the art without departing from the technical spirit of the present disclosure as set forth in the claims, and the forms also fall within the scope of the present disclosure.

1. A method of preparing a silicon/graphene composite anode material, the method comprising:
a graphene oxide preparation step of preparing an aqueous graphene oxide solution through a modified Hummer's method;
a reduced graphene oxide preparation step of preparing reduced graphene oxide powder by freeze-drying and then thermally reducing the aqueous graphene oxide solution obtained in the graphene oxide preparation step;
a composite dispersion solution preparation step of preparing a composite dispersion solution by adding a silicon metal particle, a cross-linking agent, and a water-soluble polymer to the aqueous graphene oxide solution obtained in the graphene oxide preparation step and the reduced graphene oxide powder obtained in the reduced graphene oxide preparation step, and then stirring and dispersing the mixture; and
a composite powder preparation step of preparing silicon/graphene composite powder with a core-shell structure by spray-drying the composite dispersion solution obtained in the composite dispersion solution preparation step.

2. The method of claim 1, wherein in the graphene oxide preparation step, the aqueous graphene oxide solution is prepared through the modified Hummer's method, the method comprising:
an oxidation step of preparing a graphite oxide slurry by mixing expanded graphite, potassium permanganate, water, and sulfuric acid, stirring the mixture, and reacting the mixture at a predetermined consistent temperature for a predetermined time;
a filtration step of mixing 50 to 200 parts by weight of water, based on 100 parts by weight of the prepared graphite oxide slurry, with the slurry, and then centrifuging the mixture to remove the filtrate and obtain the graphite oxide slurry; and
a graphene oxide preparation step of preparing the aqueous graphene oxide solution by mixing 5000 to 20000 parts by weight of water, based on 100 parts by weight of graphite oxide slurry separated in the filtration step, with the slurry, and then removing impurities in an ion exchange resin column and filtering out impurities.

3. The method of claim 1, wherein the graphene oxide and reduced graphene oxide have a lateral size in a range of 1 to 100 μm based on a medium particle size (D50) and a thickness in a range of 0.6 to 10 nm.

4. The method of claim 1, wherein in the composite dispersion solution preparation step, the aqueous graphene oxide solution/reduced graphene oxide powder mixture is added and dispersed in an amount of 1 to 3 parts by weight, based on 100 parts by weight of the silicon metal particle.

5. The method of claim 2, wherein the aqueous graphene oxide solution/reduced graphene oxide powder mixture is obtained by mixing the reduced graphene oxide powder with the aqueous graphene oxide solution, the reduced graphene oxide powder being in an amount of within 200 parts by weight, based on 100 parts by weight of the aqueous graphene oxide solution.

6. The method of claim 1, wherein the silicon metal particle has a size in a range of 0.05 to 5 μm.

7. The method of claim 6, wherein the silicon metal particle has a size in a range of 0.5 to 1 μm.

8. The method of claim 1, wherein in the composite dispersion solution preparation step, a commercial carbon source made of at least one selected from the group consisting of natural graphite, artificial graphite, carbon black, acetylene black, graphite intercalated compounds (GICs), expanded graphite, activated carbon, graphene nanoplatelets (GNPs), and carbon nanotubes (CNTs) is further added, dispersed, and mixed.

9. The method of claim 1, wherein the cross-linking agent is made of a monomer containing a silicate.

10. The method of claim 9, wherein the monomer containing silicate is any one selected from the group consisting of tetraethoxysilane, n-octyltriethoxysilane, siloxane, and vinyltrimethoxysilane.

11. The method of claim 1, wherein in the composite dispersion solution preparation step, a silicate salt is further comprised.

12. The method of claim 1, wherein the water-soluble polymer is at least one selected from the group consisting of polyvinyl alcohol, polyethylene glycol, polyethyleneimine, polyamideamine, polyvinyl formamide, polyvinyl acetate, polyacrylamide, polyvinylpyrrolidone, polydiallyldimethylammonium chloride, polyethyleneoxide, polyacrylic acid, polystyrenesulfonic acid, polysilicic acid, polyphosphoric acid, polyethylenesulfonic acid, poly-3-vinyloxypropane-1-sulfonic acid, poly-4-vinylphenol 4-vinylphenol, poly-4-vinylphenyl sulfuric acid, polyethyleneohosphoric acid, polymaleic acid, poly-4-vinylbenzoic acid, methyl cellulose, hydroxy ethyl cellulose, carboxy methyl cellulose, sodium carboxy methyl cellulose, hydroxy propylcellulose, sodium carboxymethylcellulose, polysaccharide, and starch, and mixtures thereof.

13. The method of claim 1, wherein in the composite powder preparation step, the composite dispersion solution obtained in the composite dispersion solution preparation step is spray-dried at a temperature in a range of 100° C. to 250° C.

14. The method of claim 1, wherein the composite powder obtained in the composite powder preparation step has a size in a range of 1 to 100 μm.

15. The method of claim 1, after the composite powder preparation step, further comprising heat-treating the composite powder obtained in the composite powder preparation step at a temperature in a range of 100° C. to 500° C. for 30 minutes to 4 hours under any gas atmosphere of air, nitrogen, or argon.

16. A silicon/graphene composite anode material having a core-shell structure, wherein the core is made of silicon metal particles and the shell is made of graphene.

17. A silicon/graphene composite anode material having a core-shell structure, the anode material being prepared according to the method of claim 15.
